(19) United States
(12) Patent Application Publication
(10) Pub. No.: US 2017/0285259 A1
(43) Pub. Date: Oct. 5, 2017

(54) OPTICAL FIBER PREFORM, OPTICAL FIBER, AND METHOD OF MANUFACTURING OPTICAL FIBER

(71) Applicant: Fujikura Ltd., Tokyo (JP)

(72) Inventor: Katsubumi Nagasu, Sakura-shi (JP)

(73) Assignee: Fujikura Ltd., Tokyo (JP)

(21) Appl. No.: 15/506,873

(22) PCT Filed: Jun. 10, 2016
(86) PCT No.: PCT/JP2016/067389

§ 371 Date: Feb. 27, 2017

(30) Foreign Application Priority Data
Jul. 15, 2015 (JP) 2015-141567

(51) Int. Cl. G02B 6/02; C03B 37/025; C03C 13/04; C03B 37/018

(52) U.S. Cl. CPC G02B 6/02395; C03B 37/018; C03B 37/025; C03C 13/045

(57) ABSTRACT

An optical fiber preform includes: a core formed of silica glass which does not contain Ge, wherein the core has at least one of characteristics in spectrometry of (1) an absorption peak is present at a wavelength of 240 nm to 255 nm, and (2) a wavelength at which an ultraviolet transmittance is 50% or lower is longer than 170 nm.

### TECHNICAL FIELD

The present invention relates to an optical fiber preform capable of reducing transmission loss in an optical fiber after drawing, an optical fiber obtained by drawing the optical fiber preform, and a method of manufacturing an optical fiber.

Priority is claimed on Japanese Patent Application No. 2015-141567, filed on Jul. 15, 2015, the content of which is incorporated herein by reference.

### BACKGROUND ART

A so-called pure silica core optical fiber in which pure silica glass is used for a core and silica glass doped with fluorine is used for a cladding is capable of achieving lower transmission loss compared to a general Ge doped core optical fiber in which silica glass doped with germanium oxide is used for a core and pure silica glass is used for a cladding in theory. This is because since a core through which most of light propagated in an optical fiber passes is formed of only silica glass, a fluctuation in concentration does not substantially occur and Rayleigh scattering is reduced.

However, Rayleigh scattering occurs due to not only a fluctuation in concentration of glass but also a fluctuation in density of glass. Thus, even in a pure silica core optical fiber, Rayleigh scattering is not sufficiently reduced and transmission loss is mostly caused by Rayleigh scattering. There have been proposed a large number of methods of reducing Rayleigh scattering by reducing a fluctuation in the density of a pure silica core optical fiber.

For example, in Patent Document 1, a method of doping a core with an alkali metal is proposed. A mechanism in which Rayleigh scattering is suppressed by doping a core with an alkali metal is considered as a result of a decrease in a temperature that reflects a state in which molecular vibration when liquid is turned into glass by accelerating the structural relaxation of silica in a process of cooling an optical fiber in a drawing step by lowering the melting temperature of silica glass is fixed, that is, a decrease in a fictive temperature.

In addition, in Patent Document 2, a method of reheating an optical fiber between processes of taking out the optical fiber from a heating furnace and coating the optical fiber with resin in a drawing step is proposed. It is considered that since structural relaxation proceeds and a fictive temperature is lowered by reheating the optical fiber, Rayleigh scattering is suppressed.

### PRIOR ART DOCUMENTS

### Patent Documents

[Patent Document 1] Japanese Patent No. 5625037

[Patent Document 2] Japanese Patent No. 4663277

### SUMMARY OF THE INVENTION

### Problems to be Solved by the Invention

It is possible to reduce transmission loss in an optical fiber by the method of reducing Rayleigh scattering. However, the present inventors have confirmed that there are many cases in which while Rayleigh scattering is reduced, transmission loss is not decreased.

The present invention is made in consideration of the above circumstances and an object thereof is to provide an optical fiber preform capable of reducing transmission loss in an optical fiber after drawing, an optical fiber obtained by drawing the optical fiber preform, and a method of manufacturing an optical fiber.

### Means for Solving the Problems

In order to solve the above problems, an optical fiber preform according to a first aspect of the present invention includes a core formed of silica glass which does not contain Ge, in which the core has at least one of characteristics in spectrometry of (1) an absorption peak is present at a wavelength of 240 nm to 255 nm, and (2) a wavelength at which an ultraviolet transmittance is 50% or lower is longer than 170 nm.

The core may be formed of pure silica glass or pure silica glass including chlorine.

The optical fiber preform may further include a cladding formed of silica glass doped with fluorine on an outer circumference of the core.

An optical fiber according to a second aspect of the present invention, that is obtained by drawing the optical fiber preform according to the above aspect, in which loss obtained by subtracting loss by Rayleigh scattering and imperfection loss from a total loss is 0.03 dB/km or less at a wavelength of 1550 nm, a total loss at a wavelength of 1550 nm is 0.175 dB/km or less, and an increase in loss by an OH group after the optical fiber is exposed to hydrogen gas at room temperature and 0.01 atmospheric pressure is 0.05 dB/km or less at a wavelength of 1383 nm.

A method of manufacturing an optical fiber according to a third aspect of the present invention includes drawing the optical fiber preform according to the above aspect.

The method may further include checking that the optical fiber preform has at least one of the characteristics of (1) and (2).

### Effects of Invention

According to the aspects of the present invention, the core of the optical fiber preform can have optical characteristics caused by oxygen deficient center (ODC). Thus, even when an oxygen-excess defect which causes loss in the general wavelength band of an optical fiber, for example, a C band (1530 to 1565 nm), is generated during drawing, it is possible to reduce the oxygen-excess defect by combining excessive oxygen atoms in the oxygen-excess defect with ODC. Accordingly, it is possible to reduce the transmission loss in the obtained optical fiber in the wavelength band. In addition, the generation of non-bridging oxygen hole center (NBOHC) can be suppressed at the same time and thus hydrogen resistance can be also satisfactory.

### BRIEF DESCRIPTION OF THE DRAWINGS

FIG. 1 is a graph showing an example of ultraviolet transmittance characteristics of a core region.

FIG. 2 is a graph showing near an a region in FIG. 1 in an enlarged manner.

FIG. 3 is a graph showing an example of a relationship between a wavelength of transmittance 50% and loss C.

FIG. 4 is a graph showing an example of a relationship between a 248 nm peak depth and loss C.

FIG. 5 is a graph showing an example of a relationship between a wavelength of transmittance 50% and transmission loss.

FIG. 6 is a graph showing an example of a relationship between a wavelength of transmittance 50% and a 248 nm peak depth.

FIG. 7 is a graph showing an example of a result of a 1% hydrogen exposure test.

### EMBODIMENTS FOR CARRYING OUT THE INVENTION

Hereinafter, the present invention will be described based on preferred embodiments.

An optical fiber preform according to an embodiment of the embodiment has a core formed of silica glass which does not contain Ge. Accordingly, it is possible to reduce Rayleigh scattering. The core of the optical fiber preform is a region which becomes a core of an optical fiber. As a dopant that can be added to the entire or partial area of the core, one or more of elements of alkali metals (Li, Na, K, Rb, and Cs), fluorine (F), chlorine (CI), and the like may be used. As the silica glass for forming the core, pure silica glass or pure silica glass including chlorine is preferable. The pure silica glass is formed of silica (SiO₂) not containing a dopant but may contain unavoidable impurities, defects, and the like. The pure silica glass can contain chlorine. In this case, only chlorine can be substantially added to the pure silica glass as a dopant.

However, there are cases in which while Rayleigh scattering is reduced by the core not containing Ge, transmission loss is not decreased. Thus, it is required to investigate other factors for causing transmission loss in the optical fiber.

The transmission loss in the optical fiber in a wavelength region of 1000 nm to 1700 nm can be expressed by Equation 1 below.

(Transmission loss)=Rayleigh scattering loss (A)÷Imperfection loss (Structural disorder loss) (B)÷Other loss (C) (Equation 1)

The loss by Rayleigh scattering is proportional to 1/the fourth power of a wavelength λ (λ⁻⁴). Generally, the imperfection loss does not depend on a wavelength λ. Thus, when the wavelength characteristics of the transmission loss (wavelength dependency) is measured, the transmission loss (total loss) can be divided into three types of loss A caused by Rayleigh scattering, imperfection loss B, and other loss C. For other loss C, there are ultraviolet absorption on the short wavelength side, Si—O infrared absorption on the long wavelength side, and absorption by an OH group at 1383 nm as a central wavelength. Here, in the specification, a value obtained by subtracting the loss A caused by Rayleigh scattering and the imperfection loss B from the measured transmission loss value is referred to as loss C. For example, in the equation shown in the paragraph 0009 of Japanese Unexamined Patent Application, First Publication No. 2003-75293 (Reference Document 1), the first item is loss by Rayleigh scattering, the second item is imperfection loss, K_{UV}-w-exp(C_{UV}/λ) of the third item is loss by ultraviolet absorption, and E(λ) of the fourth item is loss by defects. Here, λ represents a wavelength, w represents a GeO₂ concentration (wt %), K_{UV} and C_{UV} represent constants, and E(λ) is a function of λ. The loss C in the specification is calculated by obtaining loss by Rayleigh scattering and imperfection loss and further obtaining a difference obtained by subtracting the loss from the total loss, as in Reference Document 1. However, in Reference Document 1, loss by Ge doping (third item) and the like are also considered but the content of the loss C in the specification does not necessarily correspond to the third item or the fourth item of Reference Document 1.

In the case in which the transmission loss of the optical fiber is measured in a wavelength region of 1000 nm to 1700 nm and is applied to Equation 1, it is determined that there is a great difference in loss C between an optical fiber in which the transmission loss at a wavelength near 1550 nm is decreased as expected and an optical fiber in which the transmission loss is not decreased. Although the loss C at 1550 nm includes loss by Si—O infrared absorption, the loss C differs depending on fibers and thus it is expected that the loss also includes loss by factors other than Si—O infrared absorption.

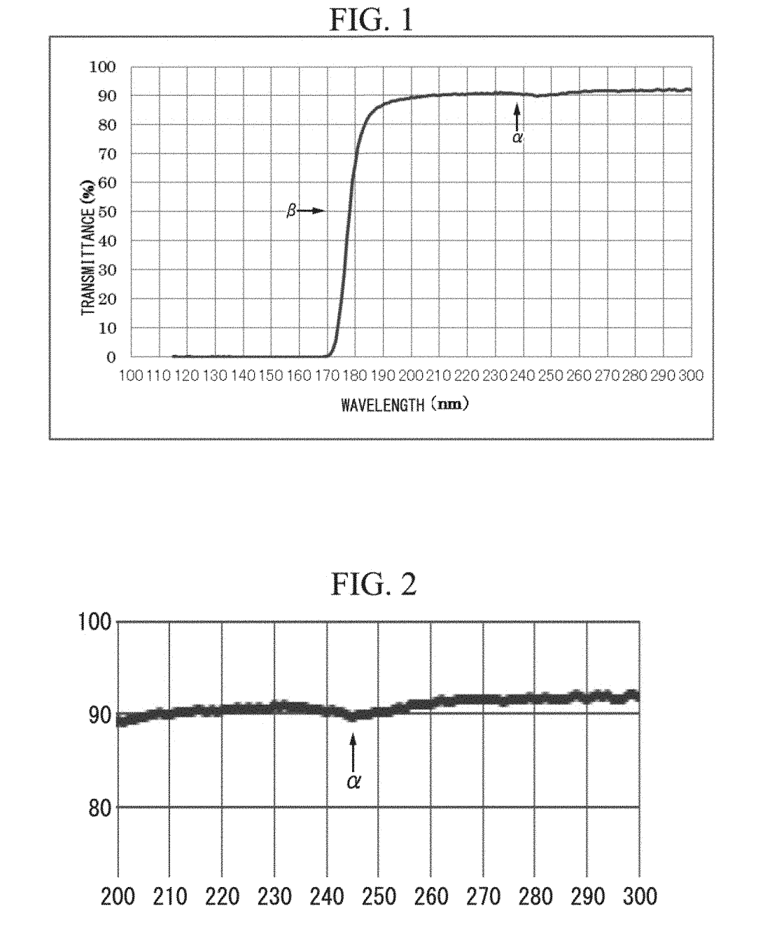

As a result of conducting various investigations based on such results, it has been found that the magnitude of loss C and transmittance characteristics in a vacuum ultraviolet wavelength region of the core glass are correlated with each other. When part of the optical fiber preform is cut into a round slice, a columnar sample is taken out, and the core region is set to a sample chamber of a vacuum ultraviolet spectrophotometer to measure a transmittance in an ultraviolet wavelength region (ultraviolet transmittance), the transmission characteristics shown in FIG. 1 can be obtained. In this example, a high transmittance continues from a measurement upper limit wavelength of 300 nm to a short wavelength but the transmittance is rapidly decreased to 0% at a wavelength near 180 nm.

According to the graph in FIG. 1, the first characteristic is that an absorption peak is present at a wavelength of 240 nm to 255 nm in the near-ultraviolet wavelength region (where the wavelength in the ultraviolet region is 200 nm or more). In FIG. 1, reference symbol α is assigned to this absorption peak. The absorption peak has at least one absorption local maximum (that is, the local minimum value of transmittance) within the range of the wavelength region.

In addition, the second characteristic is that in a vacuum ultraviolet wavelength region (where the wavelength in the ultraviolet region is 200 nm or less), a wavelength at which the ultraviolet transmittance is 50% or lower (a wavelength of transmittance 50%) is longer than 170 nm. In FIG. 1, reference symbol β is assigned to a position corresponding to this wavelength. In a case where a plurality of wavelengths at which the ultraviolet transmittance with respect to the same sample is 50% is present, the longest wavelength out of the wavelengths is set to a “wavelength of transmittance 50%”. The core satisfying the characteristics has a transmittance of higher than 50% in the ultraviolet region having a wavelength longer than the wavelength of transmittance 50%. General silica glass has a higher transmittance even in a wavelength region from visible light to near-infrared rays near a wavelength of 2 μm.

It is stated that there is absorption due to OIDC (Si—Si), which is oxygen deficient center, at a wavelength of 163 nm. Thus, regarding the second characteristic, it is considered that a rapid decrease in transmittance in the vacuum ultraviolet wavelength region is caused by ODC. In addition, in the transmittance characteristics in FIG. 1, a slight absorption peak can be confirmed near a wavelength of 248 nm. FIG. 2 shows part of the ca region in FIG. 1 in an enlarged manner. Similar to FIG. 1, the vertical axis of FIG. 2 indicates a transmittance (%) and the horizontal axis of FIG. 2 indicates a wavelength (nm). Since it is stated that there is also absorption of ODC (Si—Si) near a wavelength of 248 nm, regarding the first characteristic, it is considered that minute absorption at a wavelength of 248 nm is caused by ODC.

Specifically, although described below in Examples, regarding spectral characteristics (hereinafter, “ultraviolet transmittance characteristics”) in the ultraviolet wavelength region, when the core of the optical fiber preform has at least one of the above-described first characteristic and the above-described second characteristic, the loss C tends to decrease. From this result, it is presumed that a loss factor of the loss C other than Si—O infrared absorption is one to be consumed by ODC, that is, absorption by any defect including an oxygen atom (oxygen-excess defect).

It is presumed that as the amount of ODC in the glass is increased, the oxygen atom in the oxygen-excess defect is bonded to Si of ODC to form Si—O—Si and thus the loss C is reduced. It is presumed that the oxygen-excess defect is generated at the time of formation of soot in the core region, dehydration sintering of soot in the core region, drawing, or the like, and the bonding of ODC and the oxygen atom occurs between the processes of melting the optical fiber preform in a heating furnace during drawing and cooling the drawn optical fiber.

As described above, it can be presumed that as the amount of ODC in the core of the optical fiber preform is increased, the oxygen atom in the oxygen-excess defect is bonded to a Si atom in ODC and thus the loss C of the optical fiber is reduced. In this manner, it is possible to confirm that the amount of ODC is sufficient by measuring at least one of absorption at a wavelength of 163 nm and absorption at a wavelength of 248 nm in the core of the optical fiber preform.

The ultraviolet transmittance characteristics of the core region of the optical fiber preform have been described and the core region of the optical fiber preform corresponds to a region through which an optical signal passes in the optical fiber obtained by drawing. Here, it is desirable that the optical fiber preform have the similar ultraviolet transmittance characteristics over the entire core region. The ultraviolet transmittance of the core region is measured preferably at least one point and more preferably two or more points along the length direction, radius direction, or another direction of the optical fiber preform.

The thickness direction of the sample used in the ultraviolet spectral measurement (the measurement direction through which light passes) is not particularly limited and can be selected from the length direction, radius direction, and another direction of the optical fiber preform. The thickness of the sample used at the ultraviolet spectral measurement is not particularly limited. For example, the thickness is 1 to 10 mm and specifically 5 mm. In Examples shown below, measurement is performed at 5 mm and thus in the case of performing measurement at thicknesses other than 5 mm, the measured value may be converted so as to obtain ultraviolet transmittance characteristics at a thickness of 5 mm. In the case in which the length direction of the optical fiber preform is the measurement direction, even in a case in which a cladding is provided around the core, the spectral measurement of the core can be performed without removing cladding, and thus this case is preferable.

The ultraviolet transmittance characteristics of the optical fiber preform can be mainly controlled by the manufacturing conditions of the core region of the optical fiber preform. The core region of the optical fiber preform is prepared by, for example, a VAD method. The shape of the core region is a columnar rod shape, for example. Instead of using a glass preform prepared by a VAD method or the like as a core preform as it is, a glass preform which is elongated to have an appropriate thickness by a general method can be used as a core preform.

In the VAD method, first, it is possible to obtain transparent core glass by allowing a raw material for silica glass such as silicon tetrachloride (SiCl₄) to flow in oxyhydrogen flame to accumulate silica soot on a target, then performing dehydration by heating in an atmosphere of an inert gas including a dehydrating agent or the like, and finally, further increasing the heating temperature in a He gas atmosphere to sinter the soot. Examples of the dehydrating agent include chlorine (Cl₂) and chlorine compounds such as thionyl chloride (SOCl₂). Examples of the inert gas include helium (He) and argon (Ar).

The ultraviolet transmittance characteristics of the core glass can be changed by controlling one or more of gas conditions such as the amount of oxygen flowing, the amount of hydrogen flowing, the amount of raw material flowing, and the flow rate of each gas at the time of silica soot accumulation, and various manufacturing conditions such as the chlorine concentration, the oxygen concentration, and the treatment temperature during dehydration or sintering of the silica soot.

The cladding region of the optical fiber preform can be obtained by forming cladding glass on the outer circumference of the core region by a general outside vapor-phase deposition method. For the cladding glass, silica glass doped with an additive such as fluorine (F), boron (B), and the like, for lowering a refractive index is preferable. Examples of other cladding materials include multicomponent glass such as fluoride glass, and optical resins such as acrylic resin and fluororesin. The cladding can have two or more regions in which the glass composition, the physical properties, and the like are different.

In the outside vapor-phase deposition method, it is possible to form a cladding made of transparent glass by accumulating silica soot on the outer circumference of the core preform, then performing dehydration by heating in an atmosphere of an inert gas including a dehydrating agent or the like, and next, performing sintering in an atmosphere of He gas and the like. As a method of doping the cladding glass with fluorine, a method of adding a fluorine source into an atmosphere of He gas and the like at the time of sintering of the silica soot after dehydration, and a method of adding a fluorine source into a raw material gas to be supplied in oxyhydrogen flame at the time of accumulation of the silica soot (outside vapor-phase deposition) may be used. Examples of the fluorine source include fluorine compounds such as silicon tetrafluoride (SiF₄), carbon tetrafluoride (CF₄), and sulfur hexafluoride (SF₆).

In order to obtain a desired radius ratio between the core and the cladding, the outside vapor-phase deposition of the cladding can be repeated several times. In the case in which the outside vapor-phase deposition of the cladding is repeated several times, the glass composition of a cladding layer formed in each outside vapor-phase deposition step may be the same or different. In order to obtain desired ultraviolet transmittance characteristics, one or more of the gas conditions such as the amount of oxygen flowing, the amount of hydrogen flowing, the amount of raw material flowing, and the flowing rate of each gas at the time of accumulation of the silica soot when the cladding layer is formed, and various manufacturing conditions such as the chlorine concentration, the oxygen concentration, and the treatment temperature during dehydration or sintering of the silica soot may be adjusted.

The manufacturing of an optical fiber using the optical fiber preform according to the embodiment can be performed by a general drawing step. The length direction of the optical fiber preform is substantially vertically disposed, and the lower portion of the optical fiber preform is pulled downward in a state in which the optical fiber preform is melted by heating so that fine fibrous (fiber) glass can be drawn. The drawn glass fiber is gradually cooled in the air while being drawn and then is wounded around a bobbin or the like.

In order to protect the glass fiber at the time of drawing the optical fiber, one or more coating layers of resin can be provided on the outer circumference of the glass fiber before being wound around the bobbin or the like. The resin is not particularly limited and examples thereof include ultraviolet (UV) curable resins and thermosetting resins such as various acrylates.

Before the drawing step of the optical fiber, it is preferable to perform a step of confirming whether or not the optical fiber preform has at least one of characteristics of (1) an absorption peak is present within a wavelength range of 240 nm to 255 nm, and (2) a wavelength at which an ultraviolet transmittance is 50% or lower is longer than 170 nm. The step of checking these ultraviolet transmittance characteristics may be carried out on the optical fiber preform having the same radius ratio between the core and the cladding as that of the optical fiber as a target. As long as the ultraviolet transmittance characteristics of the core region can be confirmed, the ultraviolet transmittance characteristics may be measured at the stage of the core preform or the stage in which the outside vapor-phase deposition of the cladding is partially not performed.

As described above, the fact that the optical fiber preform has at least one of characteristics of (1) an absorption peak is present within a wavelength range of 240 nm to 255 nm, and (2) a wavelength at which an ultraviolet transmittance is 50% or lower is longer than 170 nm indicates that a sufficient amount of ODC) is present in the core glass. In the optical fiber preform having such a core, even when an oxygen-excess defect which becomes a loss factor near 1550 nm is generated in the drawing step or the like, the oxygen-excess defect can be reduced by bonding oxygen in the oxygen-excess defect to the Si atom in ODC. Accordingly, the optical fiber obtained in this manner can reduce the loss near a wavelength of 1550 nm. In addition, since the generation of non-bridging oxygen hole center (NBOHC) can be suppressed at the same time, the hydrogen resistance of the optical fiber also becomes satisfactory.

The loss C of the obtained optical fiber is preferably 0.03 dB/km or less. In addition, the total loss of the obtained optical fiber at a wavelength of 1550 nm is preferably 0.175 dB/km or less. After the obtained optical fiber is exposed to a hydrogen gas of 0.01 atmospheric pressure at room temperature, an increase in the loss caused by an OH group is preferably 0.05 dB/km or less at a wavelength of 1383 nm.

The present invention has been described based on the preferred embodiments above. However, the present invention is not limited to the above-described embodiments and various modifications can be made within a range not departing from the present invention.

The type of optical fiber is not particularly limited and examples thereof include various optical fibers such as single mode fiber (SMF), multimode fiber (MMF), few-mode fiber (FMF), multicore fiber (MCF), dispersion compensating fiber (DCF), non-zero dispersion shift fiber (NZ-DSF), dispersion shift fiber (DSF), polarization maintaining fiber (PMF), cut-off shift fiber, and bundle fiber.

### Examples

Hereinafter, the present invention will be specifically described with reference to examples.

The core region of an optical fiber preform was prepared by a VAD method. In the VAD method, accumulated silica soot was dehydrated by heating in a helium (He) gas atmosphere including chlorine (Cl₂) as a dehydrating agent and then the heating temperature was further increased in the He gas atmosphere to sinter the soot. Thus, transparent core glass was obtained. Dehydration was performed at a dehydrating agent concentration in a range of 0.2 to 6.0 mol %, an oxygen concentration in a range of 0 to 1 mol %, and a dehydration temperature in a range of 1000° C. to 1300° C. and sintering was performed at a dehydrating agent concentration in a range of 0 to 6.0 mol %, an oxygen concentration in a range of 0 to 1 mol %, and a sintering temperature in a range of 1380° C. to 1500° C. Thus, core glass having various ultraviolet transmittance characteristics was obtained.

After the core glass prepared as described above was elongated to have an appropriate thickness by a general method, pure silica soot was vapor-deposited to the outside of the core preform which had been elongated by a general outside vapor-phase deposition and then was dehydrated by heating in a SOCl₂/He mixed gas atmosphere. Next, the silica soot was sintered in a He gas atmosphere including silicon tetrafluoride (SiF₄) as a fluorine source so that transparent glass doped with fluorine (F doped cladding) was formed (vapor-deposited) on the outer circumference of the core glass. Further, the outside vapor-deposition of the F doped cladding was repeated so as to have a desired radius ratio between the core and cladding and thus an optical fiber preform was prepared.

Part of the optical fiber preform obtained as described above was cut into a round slice, a columnar sample having a thickness of 5 mm was taken out, and the core region was set to a sample chamber of a vacuum ultraviolet spectrophotometer. Then, the transmittance in the vacuum ultraviolet wavelength region was measured. As the vacuum ultraviolet spectrophotometer, V-1000 (having a measurement wavelength range of 115 to 300 nm) manufactured by JASCO Corporation was used.

In FIG. 1, an example of the ultraviolet transmittance characteristic obtained in the measurement is shown. The characteristics that a high transmittance continues from the measurement upper limit wavelength of 300 nm to a short wavelength but the transmittance is rapidly decreased to 0% near 180 nm were obtained. In addition, a slight absorption peak could be confirmed near 248 nm. The wavelength at which the transmittance is 50% (hereinafter, “wavelength of transmittance 50%”) was 178 nm and the peak depth at a wavelength of 248 nm (hereinafter, “248 nm peak depth”) was 1.2%.

The remaining optical fiber preform was drawn at a drawing speed of 100 m/min to prepare an optical fiber and the transmission loss was measured within a range of 1000 nm to 1700 nm. The loss by Rayleigh scattering and imperfection loss and the loss C were separately obtained from the value of the wavelength dependency of the (total) transmission loss obtained in the measurement using Equation 1.

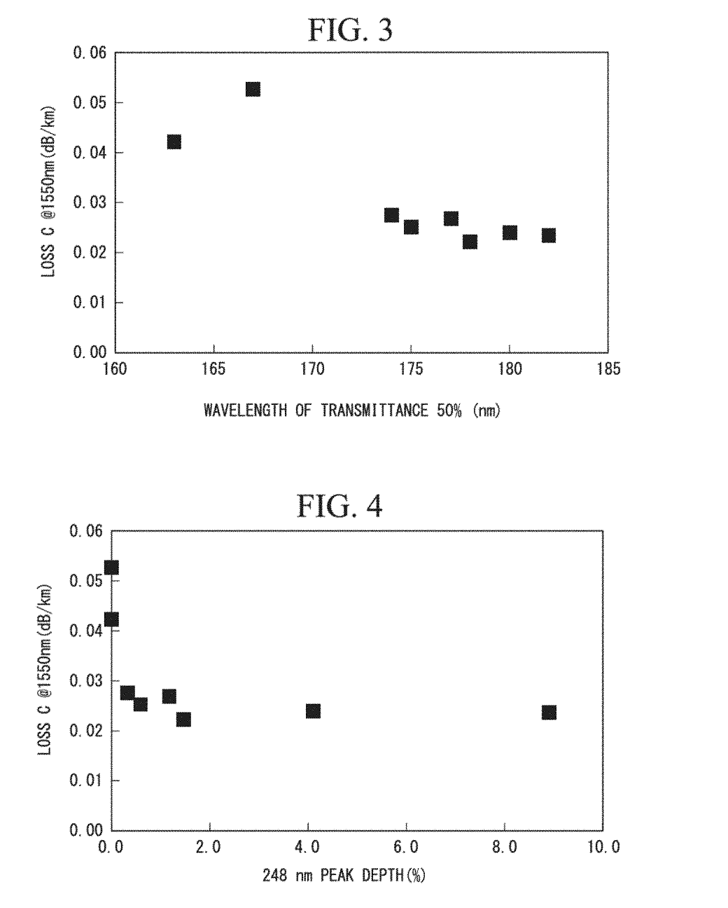

In this manner, the optical fiber preform was drawn under the same conditions as in the measurement of the transmittance in the vacuum ultraviolet wavelength region and regarding some of samples of which the transmission loss was tried to be measured, the wavelength of transmittance 50% (nm), the total transmission loss (dB/km) at a wavelength of 1550 nm, the loss C (dB/km) at a wavelength of 1550 nm, and the 248 nm peak depth (%) were obtained. The results are shown in Table 1. The column “@ (wavelength)” represented “at (wavelength)”. In addition. FIGS. 3 to 6 are graphs in which the results of Table 1 are plotted.

TABLE 1

| | Total | | |
|---|---|---|---|
| Wavelength of | transmission | | |
| transmittance | loss @1550 | Loss C @1550 | 248 nm peak |
| 50% (nm) | nm (dB/km) | nm (dB/km) | depth (%) |
| 163 | 0.197 | 0.042 | 0.0 |
| 167 | 0.221 | 0.053 | 0.0 |
| 174 | 0.179 | 0.027 | 0.3 |
| 175 | 0.169 | 0.025 | 0.6 |
| 177 | 0.170 | 0.027 | 1.2 |
| 178 | 0.173 | 0.022 | 1.5 |
| 180 | 0.169 | 0.024 | 4.1 |
| 182 | 0.170 | 0.024 | 8.9 |

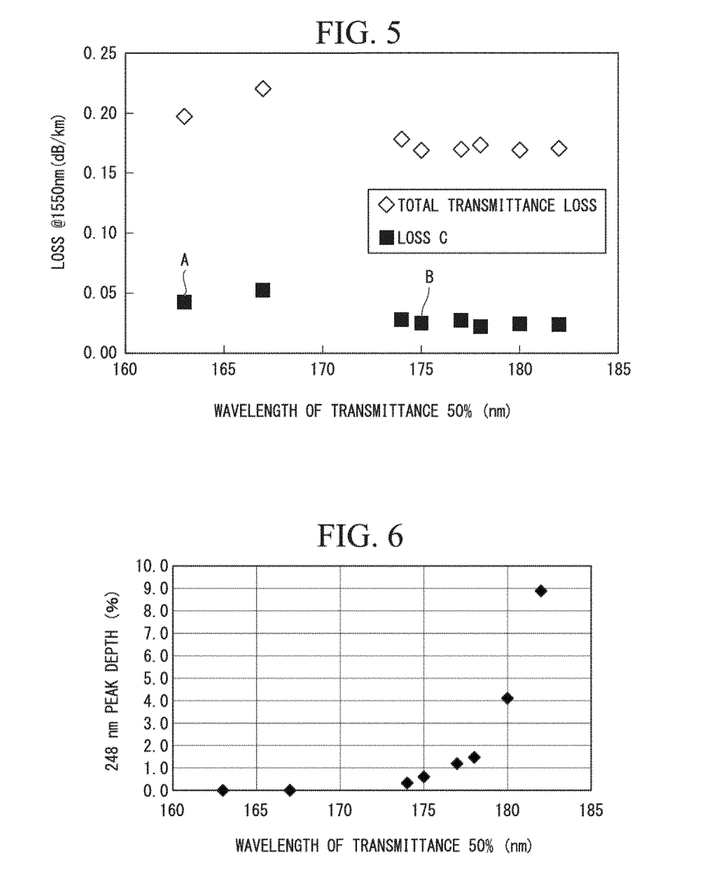

FIG. 3 is a graph obtained by plotting a wavelength of transmittance 50% on the horizontal axis and loss C at 1550 nm on the vertical axis. FIG. 5 is graph obtained by plotting a wavelength of transmittance 50% on the horizontal axis and loss (total transmission loss and loss C) at 1550 nm on the vertical axis. In these graphs, it was found that as the wavelength of transmittance 50% becomes longer, the total transmission loss and loss C tend to decrease. In the case in which the wavelength of transmittance 50% was longer than 170 nm, the total transmission loss was decreased to 0.175 dB/km or less and the loss C was decreased to 0.03 dB/km or lower.

FIG. 4 is a graph obtained by plotting a 248 nm peak depth on the horizontal axis and loss C at 1550 nm on the vertical axis. In addition, FIG. 6 shows an example of a relationship between a wavelength of transmittance 50% and a 248 nm peak depth. As shown in FIG. 4, in the case in which no peak was observed near the 248 nm (248 nm peak depth was 0%), the loss C of the sample was increased but in the case in which a slight absorption of at least 0.3% near 248 nm could be confirmed, the loss C was decreased to less than 0.03 dB/km. In addition, as shown in FIG. 6, there is a tendency that an increase in wavelength of transmittance 50% is linked to an increase in 248 nm peak depth.

Based on the evaluation result of the transmittance characteristics in the vacuum ultraviolet region as described above, a degree of loss at 1550 nm can be evaluated.

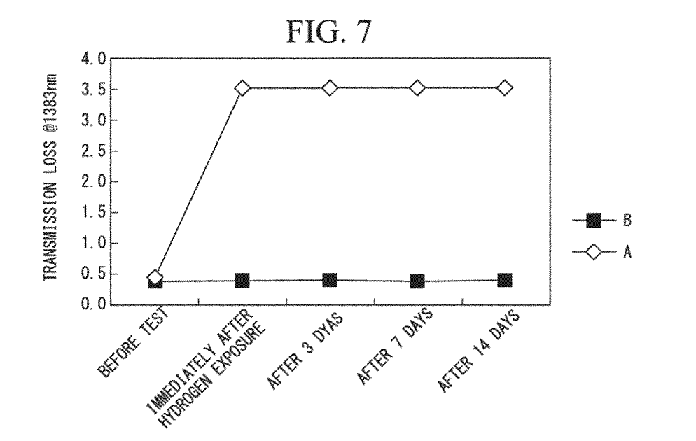

Next, a sample of the optical fiber in which a point A and a point B of FIG. 5 were plotted was subjected to a 1% hydrogen test defined by Annex C of IEC 60793-2-50. FIG. 7 is a graph showing changes of a loss value, which is absorption by an OH group, at a wavelength of 1383 nm before the test, immediately after hydrogen exposure, and for 14 days after the exposure. In FIG. 5, the loss of the sample of the point A in which the wavelength of transmittance 50% was as short as 163 nm was significantly increased by hydrogen exposure and even when the sample was stored in the atmosphere in which hydrogen was not present after the hydrogen exposure, the loss did not return to the original loss. On the other hand, in FIG. 5, the loss of the sample of the point B in which the wavelength of transmittance 50% was as long as 175 nm was not increased by hydrogen exposure and very satisfactory hydrogen resistance was exhibited.

### DESCRIPTION OF REFERENCE NUMERAL

α . . . Absorption peak by ODC
β . . . Wavelength at which ultraviolet transmittance is 50% or lower

1. An optical fiber preform comprising:
a core formed of silica glass which does not contain Ge,
wherein the core has at least one of characteristics in spectrometry of
(1) an absorption peak is present at a wavelength of 240 nm to 255 nm, and
(2) a wavelength at which an ultraviolet transmittance is 50% or lower is longer than 170 nm.

2. The optical fiber preform according to claim 1,
wherein the core is formed of pure silica glass or pure silica glass including chlorine.

3. The optical fiber preform according to claim 1, further comprising:
a cladding formed of silica glass doped with fluorine on an outer circumference of the core.

4. An optical fiber that is obtained by drawing the optical fiber preform according to claim 1,
wherein loss obtained by subtracting loss by Rayleigh scattering and imperfection loss from a total loss is 0.03 dB/km or less at a wavelength of 1550 nm,
a total loss at a wavelength of 1550 nm is 0.175 dB/km or less, and
an increase in loss caused by an OH group after the optical fiber is exposed to hydrogen gas at room temperature and 0.01 atmospheric pressure is 0.05 dB/km or less at a wavelength of 1383 nm.

5. A method of manufacturing an optical fiber comprising:
drawing the optical fiber preform according to claim 1.

6. The method of manufacturing an optical fiber according to claim 5, further comprising:
checking that the optical fiber preform has at least one of the characteristics of (1) and (2).
